(19) United States
(12) Patent Application Publication
(10) Pub. No.: US 2011/0198874 A1
(43) Pub. Date: Aug. 18, 2011

(54) Custom bumper protector

(76) Inventors: James Lee, Jamaica, NY (US); David Lee, Jamaica, NY (US)

(21) Appl. No.: 12/931,472

(22) Filed: Jan. 31, 2011

Related U.S. Application Data
(60) Provisional application No. 61/337,079, filed on Jan. 29, 2010.

(51) Int. Cl. B60R 19/44

(52) U.S. Cl. 293/142

(57) ABSTRACT

The present invention provides a removable, padded vinyl panel to be fastened over the rear bumper of a vehicle, the intent of which is to protect the bumper from scratches, dents, and dings. Manufactured by the Motor Vehicle Parts and Accessories industry, Standard Industrial Code 3714, the Custom Bumper Protector is produced in a tough, durable, UV-resistant vinyl material, with an interior lining of impact-absorbing cellular synthetic foam. While the Custom Bumper Protector is manufactured in a wide variety of lengths and widths, depending on the model of car, pickup, van, or SUV being fitted, the basic model is tapered, incorporating two side panels approximately three and one half feet in length and approximately five and one half inches in width, which extend to cover the sides of the bumper; and a longer, wider, approximately five and one half feet by approximately nine inch panel which covers the rear of the bumper. The Custom Bumper Cover is equipped with a double-stitched flange, lip, or apron designed to slip under the vehicle's trunk-lid, which is closed in order to secure the Custom Bumper Cover, and the side guard sections of the Custom Bumper Cover fasten by means of VELCRO® equipped straps.

### CLAIM OF PRIORITY

This patent application claims priority under 35 USC 119(e) (1) from U.S. Provisional Patent Application Ser. No. 61/337,079 filed Jan. 29, 2010, of common inventorship herewith entitled, “Custom Bumper Protector.”

### FIELD OF THE INVENTION

The present invention pertains to the field of automobile protection devices, and more specifically to the field of automobile bumper protection devices.

### BACKGROUND OF THE INVENTION

The prior art has put forth several designs for automobile bumper protection devices. Among these are:

U.S. Pat. No. 5,618,073 to Steven Criscione describes a protective cover for covering the outer surface of a rear bumper of a motor vehicle. The protective cover may consist of a single panel of flexible material, or alternatively, two panels of flexible material and a central portion formed from a transparent polymer that provides visual access to a rear license plate that may be located in a recess formed in the rear bumper. The protective cover is secured in place across the rear bumper. The protective cover is secured in place across the rear bumper by straps that are looped through attachment handles affixed to the motor vehicle's rear wheel.

U.S. Pat. No. 6,572,086 to Junior Kelly describes a portable cushion protector which is easily attachable to and detachable from the rear portions of an automobile and which protects its rear bumper from scratches and other damage while it is parked. The cushion protector has supporting mechanisms which may be advantageously attached to the automobile trunk for holding the cushion securely in place upon the bumper.

U.S. Pat. No. 7,073,830 to Jian Chen and Dennis Q. Chen describes a bumper protection device for automobile bumpers to shield the bumpers from impact and attaches to the automobile by a fabric shroud which attaches around the hood and trunk latch and suspends an impact resisting padded guard portion, adapted to the vehicle bumper, covering the entire front or rear bumper, the padded guard portion being drawn partially around the sides of the bumper and anchored by at least one elastic strap attached to opposing ends of the bumper guard portion, each elastic strap being further attached to the tires or wheel wells of the automobile retaining the bumper protection device over the entire rear bumper surface and around the sides of the bumper.

U.S. Patent Application 2005/0242558 to Cynthia Jean Cohen describes a protective mat made from a variety of materials ranging from cloth to leather. Once it is attached in place in the trunk or rear cargo area of a vehicle, the unattached end can be simply grasped, pulled out of the vehicle's trunk/cargo space and dropped down over the bumper.

None of these prior art references describe the present invention.

### SUMMARY OF THE INVENTION

It is an object of the present invention to provide automobile bumper protection devices.

### BRIEF DESCRIPTION OF THE DRAWINGS

FIG. 1 is an elevational angled perspective view of the device of the present invention.

FIG. 2 is an elevational right angled perspective view of the device of the present invention.

FIG. 3 is an elevational right side angled perspective view of a portion of the device of the present invention.

FIG. 4 is an elevational right side angled perspective view of another embodiment of the present invention.

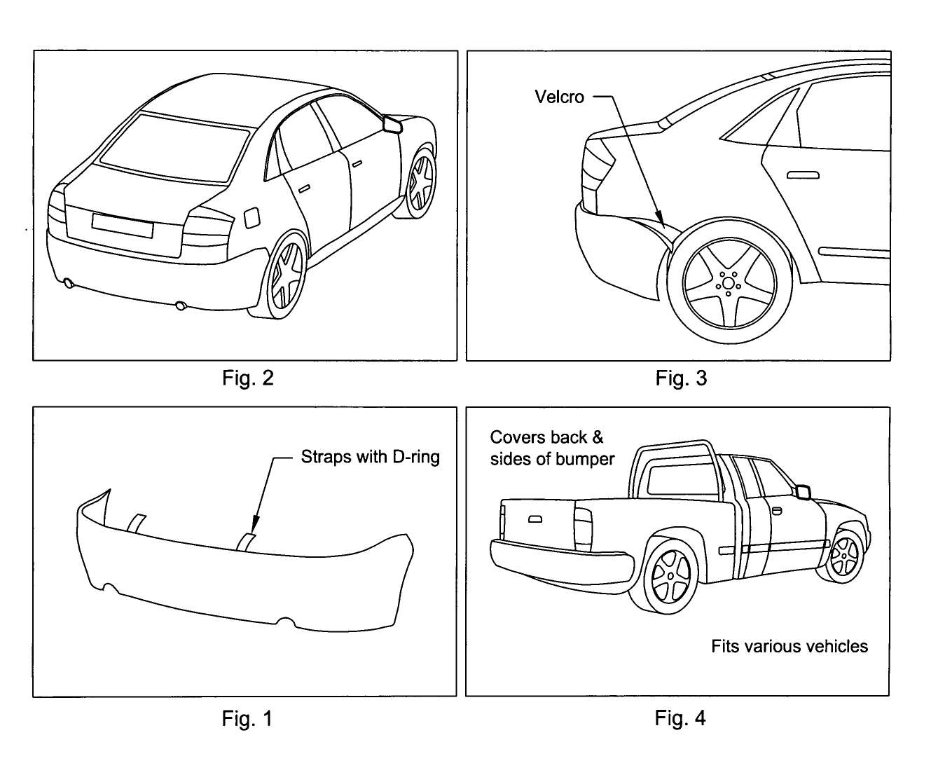

### DETAILED DESCRIPTION OF THE INVENTION

If the largest and most important single investment a consumer makes is in a house, the second largest, in most cases, is the car, or cars, they drive. Not only are home and car the most visible, expensive, and important of our possessions, but both require substantial upkeep on our part to retain their pleasing appearance and their financial value. Wise men and women throughout history have remarked that a person's self-respect extends to his or her possessions, pointing out that a self-respecting person is almost certain to have a neat and clean personal appearance, a clean and orderly home, a neat and tidy car. A self-respecting person takes care of things, keeps his or her possessions shipshape, and considers it proper and necessary to have a place for everything and everything in its place. In frontier days, such a self-reliant individual was said to “keep his powder dry and his ax sharp.” In our time, when a person's most significant possessions are his or her home and car, we keep these up with routine and regular maintenance. We steam-clean our houses, keep a good coat of paint on the walls and shingles on the roof. We have our car serviced regularly, and do our best to protect its body, paint, and finish. A house, being a stationary object, is threatened by weather, by trees, by termites, by the things around it, but a car would not be much good to us if we kept it protected in a garage and never drove it. We can do our best to park where the hazards are minimal, but taking a car out into the world is unavoidably to put that car at risk, at risk of dents and dings and scratches that occur after we've parked the car and go about our business. At particular risk is the rear bumper of the vehicle. The present invention, hereinafter referred as the Custom Bumper Protector provides a protective, attractive solution.

Simply stated, the Custom Bumper Protector is a removable, padded vinyl panel to be fastened over the rear bumper of a vehicle, the intent of which is to protect the bumper from scratches, dents, and dings. Manufactured by the Motor Vehicle Parts and Accessories industry, Standard Industrial Code 3714, the Custom Bumper Protector is produced in a tough, durable, UV-resistant vinyl material, with an interior lining of impact-absorbing cellular synthetic foam. While the Custom Bumper Protector is manufactured in a wide variety of lengths and widths, depending on the model of car, pickup, van, or SUV being fitted, the basic model is tapered, incorporating two side panels approximately three and one half feet in length and approximately five and one half inches in width, which extend to cover the sides of the bumper; and a longer, wider, approximately five and one half feet by approximately nine inch panel which covers the rear of the bumper. The Custom Bumper Cover is equipped with a double-stitched flange, lip, or apron designed to slip under the vehicle's trunk-lid, which is closed in order to secure the Custom Bumper Cover, and the side guard sections of the Custom Bumper Cover fasten by means of VELCRO® equipped straps. As noted previously, the Custom Bumper Cover is produced in a variety of lengths and widths to meet the bumper specifications of currently existing vehicles. The Custom Bumper Cover is also produced in a variety of colors, textures, and finishes. Further, the Custom Bumper Cover readily accommodates itself to the display of logos, slogans, and other graphic arts.

Use of the Custom Bumper Cover is simple and straightforward. The consumer selects the model of the Custom Bumper Cover appropriate for his or her vehicle, then lays the Cover out over the rear and side portions of the bumper, using the flange and VELCRO® fittings to fasten the Custom Bumper Cover firmly and securely in place. Thereafter, the Custom Bumper Cover requires no particular maintenance or upkeep, other than a regular washing along with the car.

The Custom Bumper Cover, a padded vinyl protective cover for the rear bumpers of automobiles, presents the auto owner with a distinct and significant benefit. The Custom Bumper Cover serves to protect the bumper from the common, annoying dings, dents, and scratches that the vehicle's rear bumper so often sustains, while adding a distinctive, personal touch to the appearance of the vehicle. Styled in a variety of colors and textures and in other embodiments equipped with an eye-catching graphic display or logo, the Custom Bumper Cover saves motorists the financial expense and the emotional frustration of having to perform touch-up paint jobs on their bumpers, as the Custom Bumper Cover fully protects the bumper's paint and finish. And because the Custom Bumper Cover is attractively styled and crafted of high-quality materials, this automotive accessory clearly enhances the beauty of any car, van, pickup, or SUV.

A protective cover for the rear bumpers of automobiles, the Custom Bumper Protector fits snugly over the vehicle's rear bumper, protecting the bumper from dings, dents, and scratches, both maintaining and enhancing the attractive appearance of the car.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An automotive bumper protection device, comprising:
a removable, padded vinyl panel to be fastened over the rear bumper of a vehicle, to protect the bumper from scratches, dents, and dings comprising a tough, durable, UV-resistant vinyl material, with an interior lining of impact-absorbing cellular synthetic foam.

2. The device of claim 1 wherein the device is fitted and tapered to embrace the vehicle bumper, comprising two side panels approximately three and one half feet in length and approximately five and one half inches in width, which extend to cover the sides of the bumper; and a longer, wider, approximately five and one half feet by approximately nine inch panel which covers the rear of the bumper.

3. The device of claim 1 further comprising a double-stitched flange, lip, or apron designed to slip under the vehicle's trunk-lid, which is closed in order to secure the device.

4. The device of claim 3 further comprising hook and loop fasteners on straps to secure the side panels to the bumper.
